(19) United States
(12) Patent Application Publication
(10) Pub. No.: US 2019/0014776 A1
(43) Pub. Date: Jan. 17, 2019

(54) AUXIN HERBICIDAL MIXTURES

(71) Applicant: Monsanto Technology LLC, St. Louis, MO (US)

(72) Inventors: John W. Hemminghaus, Chesterfield, MO (US); Gary J. Klopf, Wildwood, MO (US); John T. Whitteck, Olivette, MO (US)

(73) Assignee: Monsanto Technology LLC, St. Louis, MO (US)

(21) Appl. No.: 16/007,041

(22) Filed: Jun. 13, 2018

Related U.S. Application Data
(60) Provisional application No. 62/518,979, filed on Jun. 13, 2017.

(51) Int. Cl. A01N 25/22; A01N 25/18; A01N 25/32

(52) U.S. Cl. CPC A01N 25/22; A01N 25/18; A01N 37/40; A01N 2300/00; A01N 25/32

(57) ABSTRACT

The present disclosure relates to herbicidal mixtures comprising an auxin herbicide salt, and an adjuvant, methods of preparing such herbicidal mixtures, and methods of applying such herbicidal mixtures to kill or control unwanted plants.

### FIELD OF THE INVENTION

The present disclosure relates to herbicidal mixtures comprising an auxin herbicide salt (e.g., a dicamba salt), and an adjuvant, methods of preparing such herbicidal mixtures, and methods of applying such herbicidal mixtures to kill or control unwanted plants.

### BACKGROUND OF THE INVENTION

Auxin herbicides, such as dicamba, have proven to be effective and highly beneficial for control of unwanted plants. Generally, auxin herbicides mimic or act like natural auxin plant growth regulators. Auxin herbicides appear to affect cell wall plasticity and nucleic acid metabolism, which can lead to uncontrolled cell division and growth. The injury symptoms caused by auxin herbicides include epinastic bending and twisting of stems and petioles, leaf cupping and curling, and abnormal leaf shape and venation.

Off-site movement is sometimes associated with auxin herbicides. Under some application conditions, auxin herbicides can volatilize into the atmosphere and migrate from the application site to adjacent crop plants or non-target plants where contact damage can occur. Typical symptoms of injury to crop plants include leaf cupping, leaf malformation, leaf necrosis, terminal bud kill and/or delayed maturity.

Accordingly, there remains a need for an economic, convenient solution that reduces volatility of auxin herbicides. A solution that does not require costly modifications to existing herbicide production or formulation processes would be beneficial. Furthermore, a solution that can be used with conventional auxin herbicide formulations (e.g., concentrates) and that can be practiced in field during preparation of auxin herbicide-containing herbicide application mixtures (e.g., tank mixes) would be advantageous.

Additionally, it has been observed that auxin herbicides (e.g., dicamba) may exhibit an increase in volatility when combined with certain classes of agrochemicals. Accordingly, there remains a need for an economic, convenient solution that reduces or controls the negative effects on auxin volatility resulting from the presence of these agrochemicals.

These and/or other benefits may be provided by one or more of the herbicidal mixtures and methods disclosed herein.

### SUMMARY OF THE INVENTION

The present invention relates to herbicidal mixtures comprising an auxin herbicide salt (e.g., a dicamba salt), and an adjuvant, methods of preparing such herbicidal mixtures, and methods of applying such herbicidal mixtures to kill or control unwanted plants.

Various aspects of the present invention are directed to methods of preparing an herbicidal concentrate composition comprising an auxin herbicide salt (e.g., dicamba), wherein the method comprises combining: an auxin herbicide acid (e.g., dicamba acid); a neutralizing base comprising a first cation; and an adjuvant comprising a hydroxide salt comprising a second cation, wherein the hydroxide salt is selected from the group consisting of:

(a) a quaternary ammonium salt of Formula I

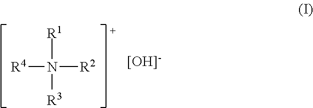

wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;

(b) a salt containing a nitrogen heterocycle of Formula II

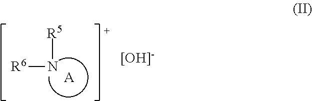

wherein A is a 5 or 6-membered heterocyclic ring; R⁵ is a C₁-C₂₀ alkyl; R⁶ is hydrogen or a C₁-C₆ alkyl;

(c) a phosphonium salt of Formula III

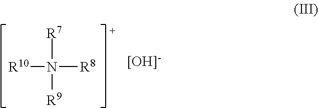

wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof.

Further aspects of the invention are directed to methods of preparing an herbicidal tank mixture. One method comprises combining: an auxin herbicide (e.g., dicamba), in the form of a salt thereof comprising a first cation; an agrochemical component comprising one or more agrochemicals that promote the volatilization of the auxin herbicide; and an adjuvant comprising a hydroxide salt comprising a second cation, wherein the hydroxide salt is as defined above and elsewhere herein. Another method comprises combining: an auxin herbicide, in the form of a salt thereof comprising a first cation; an agrochemical component comprising ammonium glufosinate; and an adjuvant comprising a hydroxide salt comprising a second cation, wherein the hydroxide salt is as defined above and elsewhere herein. A further method comprises combining: an auxin herbicide, in the form of a salt thereof comprising a first cation; an agrochemical component comprising ammonium glyphosate; and an adjuvant comprising a hydroxide salt comprising a second cation, wherein the hydroxide salt is as defined above and elsewhere herein. Yet another method comprises combining: an auxin herbicide, in the form of a salt thereof comprising a first cation; an agrochemical component comprising ammonium sulfate; and an adjuvant comprising a hydroxide salt comprising a second cation, wherein the hydroxide salt is as defined above and elsewhere herein. In these and other methods, the adjuvant can comprise tetrabutylammonium hydroxide, wherein the molar ratio of an auxin herbicide to tetrabutylammonium hydroxide is from about 2:1 to about 10:1. Various other methods comprise combining: an auxin herbicide, in the form of a salt thereof comprising a cation; and an agrochemical component comprising one or more agrochemicals that promote the volatilization of an auxin herbicide and comprising a source of ammonium ions, wherein the cation is selected from the group consisting of:

(a) a quaternary ammonium cation of Formula Ia

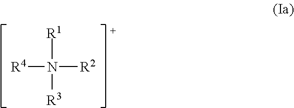

wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;

(b) a nitrogen heterocycle cation of Formula IIa

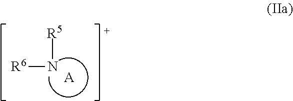

wherein A is a 5 or 6-membered heterocyclic ring; R⁵ is a C₁-C₂₀ alkyl; R⁶ is hydrogen or a C₁-C₆ alkyl;

(c) a phosphonium cation of Formula IIIa

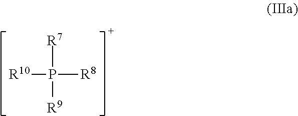

wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof.

Other aspects of the invention are directed to various herbicidal compositions. One composition comprises: an auxin herbicide (e.g., dicamba), in the form of a salt thereof comprising a first cation; an agrochemical component comprising one or more agrochemicals that promote the volatilization of an auxin herbicide; and an adjuvant comprising a second cation selected from the group consisting of:

(a) a quaternary ammonium cation of Formula Ia

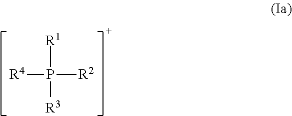

wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;

(b) a nitrogen heterocycle cation of Formula IIa

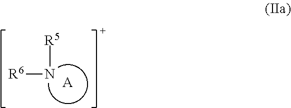

wherein A is a 5 or 6-membered heterocyclic ring; R⁵ is a C₁-C₂₀ alkyl; R⁶ is hydrogen or a C₁-C₆ alkyl;

(c) a phosphonium cation of Formula IIIa

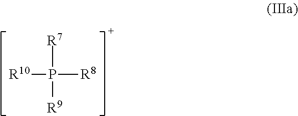

wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof, and wherein the composition comprises the auxin herbicide in a concentration of at least 240 grams per liter on an acid equivalent (a.e.) basis. A further composition comprises: a first component comprising a first auxin herbicide salt (e.g., a first dicamba salt) comprising a first cation and a first auxin herbicide anion, and a second auxin herbicide salt (e.g., a second dicamba salt) comprising a second cation and a second auxin herbicide anion; and an agrochemical component comprising one or more agrochemicals that promote the volatilization of the auxin herbicide; wherein the second cation is as defined above and elsewhere herein. Another composition comprises: an auxin herbicide (e.g., dicamba), in the form of a salt thereof comprising a cation; and an agrochemical component comprising one or more agrochemicals that promote the volatilization of the auxin herbicide and comprising a source of ammonium ions, wherein the cation is selected from the group consisting of:

(a) a quaternary ammonium cation of Formula Ia

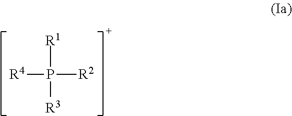

wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;

(b) a nitrogen heterocycle cation of Formula IIa

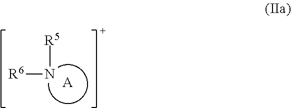

wherein A is a 5 or 6-membered heterocyclic ring; R⁵ is a C₁-C₂₀ alkyl; R⁶ is hydrogen or a C₁-C₆ alkyl;

(c) a phosphonium cation of Formula IIIa

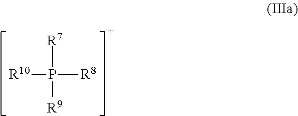

wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof.

Aspect of the present invention also include other methods including a method of reducing off-site movement of an auxin herbicide (e.g., dicamba) following application of an herbicidal mixture comprising the auxin herbicide to the foliage of plants. The method comprises, if necessary, diluting a herbicidal composition or mixture as described herein with water to form an application mixture; and applying an herbicidally effective amount of the application mixture to the foliage of the plants. Another method includes a method of killing or controlling weeds or unwanted vegetation comprising, if necessary, diluting a herbicidal composition or mixture as described herein with water to form an application mixture; and applying an herbicidally effective amount of the application mixture to the foliage of the weeds or unwanted vegetation.

Other objects and features will be in part apparent and in part pointed out hereinafter.

### BRIEF DESCRIPTION OF THE DRAWINGS

FIG. 1 shows an image of compositions taken after preparation to evaluate the physical stability of the compositions.

FIG. 2 shows an image of compositions taken after preparation to evaluate the physical stability of the compositions.

FIG. 3 shows an image of compositions taken 3 days after preparation to evaluate the physical stability of the compositions.

FIG. 4 shows an image of compositions taken 3 days after preparation to evaluate the physical stability of the compositions.

### DESCRIPTION OF THE PREFERRED EMBODIMENTS

It has been discovered that the volatility of an auxin herbicide such as dicamba can be greatly reduced by incorporating an adjuvant comprising a hydroxide salt, as described herein, into a herbicidal mixture comprising a salt of an auxin herbicide (e.g., a dicamba salt). Surprisingly, the methods and compositions described herein are effective at controlling or reducing the volatility of the auxin herbicide even in the presence of one or more compounds that increase volatility of the auxin herbicide (e.g., ammonium ions).

For example, provided herein is a method of preparing a herbicidal mixture, wherein the method comprises combining an auxin herbicide, in the form of a salt thereof; an agrochemical component comprising one or more agrochemicals that promote the volatilization of the auxin herbicide; and an adjuvant.

In various embodiments, the adjuvant comprises a hydroxide salt selected from the group consisting of:

(a) a quaternary ammonium salt of Formula I

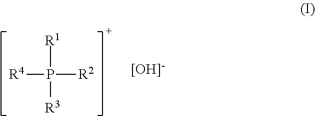

wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;

(b) a salt containing a nitrogen heterocycle of Formula II

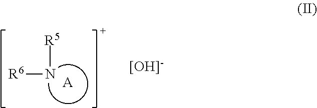

wherein A is a 5 or 6-membered heterocyclic ring; R⁵ is a C₁-C₂₀ alkyl; R⁶ is hydrogen or a C₁-C₆ alkyl; and

(c) a phosphonium salt of Formula III

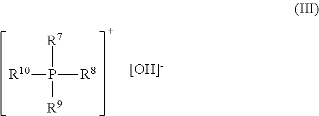

wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13. The hydroxide salts of Formulas I, II and III may be used in combination.

In the quaternary ammonium salt of Formula I, R¹, R², and R³ may each be C₃-C₁₂ alkyl or alkenyl. R⁴ may be C₃-C₁₂ hydrocarbyl, for example C₃-C₁₂ alkyl or alkenyl. Alternatively, R⁴ may be benzyl. Preferably, R¹, R², R³, and R⁴ are each independently C₃-C₁₂ alkyl.

The total number of carbon atoms in R¹, R², R³, and R⁴ is at least 13. Preferably, the total number of carbon atoms in R¹, R², R³, and R⁴ is at least 14, at least 15, at least 16, at least 17, or at least 18. For example, the total number of carbon atoms in R¹, R², R³, and R⁴ may range from 13 to about 30, from 13 to about 25, from 13 to about 20, or from 13 to about 18.

Representative alkyl groups for R¹, R², and R³ include propyl, butyl, pentyl, hexyl, heptyl, octyl, nonyl, decyl, undecyl, and dodecyl. Representative alkyl groups for R⁴ include methyl, ethyl, propyl, butyl, pentyl, hexyl, heptyl, octyl, nonyl, decyl, undecyl, and dodecyl. Preferred alkyl groups for R¹, R², and R³ include propyl, butyl, pentyl, and hexyl. Preferred alkyl groups for R⁴ include methyl, ethyl, propyl, butyl, pentyl, and hexyl. In certain embodiments, R⁴ is methyl.

In various embodiments, at least two of R¹, R², R³, and R⁴ have the same substituent (e.g., R¹ and R² are each butyl). In some embodiments, R¹, R², and R³ each have the same substituent (e.g., R¹, R², and R³ are each butyl). In certain embodiments, R¹, R², R³, and each R⁴ have the same substituent (e.g., R¹, R², R³, and R⁴ are each butyl)

Preferred species of the quaternary ammonium salt of Formula I include tributylmethylammonium hydroxide and tetrabutylammonium hydroxide.

In the salt containing a nitrogen heterocycle of Formula II, ring A is preferably a substituted imidazole ring, a substituted pyridine ring, or a substituted pyrrolidine ring. R⁵ is preferably C₁-C₁₂ alkyl. In preferred embodiments, the salt of Formula II is selected from the group consisting of 1-butyl-1-methyl-pyrrolidinium hydroxide, 1-ethyl-3-methylimidazolium hydroxide, 1-butyl-3-methylimidazolium hydroxide, 1-methyl-3-octylimidazolium hydroxide, and cetylpyridinium hydroxide.

In the phosphonium salt of Formula III, R⁷, R⁸, and R⁹ may each be C₃-C₁₂ alkyl or alkenyl. R¹⁰ may be C₃-C₁₂ hydrocarbyl, for example C₃-C₁₂ alkyl or alkenyl. In other embodiments, R¹⁰ is benzyl. Preferably, R⁷, R⁸, R⁹, and R¹⁰ are each independently C₃-C₁₂ alkyl.

The total number of carbon atoms in R⁷, R⁸, R⁹, and R¹⁰ is at least 13. Preferably, the total number of carbon atoms in R⁷, R⁸, R⁹, and R¹⁰ is at least 14, at least 15, at least 16, at least 17, or at least 18. For example, the total number of carbon atoms in R⁷, R⁸, R⁹, and R¹⁰ may range from 13 to about 30, from 13 to about 25, from 13 to about 20, or from 13 to about 18.

Representative alkyl groups for R⁷, R⁸, and R⁹ include propyl, butyl, pentyl, hexyl, heptyl, octyl, nonyl, decyl, undecyl, and dodecyl. Representative alkyl groups for R¹⁰ include methyl, ethyl, propyl, butyl, pentyl, hexyl, heptyl, octyl, nonyl, decyl, undecyl, and dodecyl. Preferred alkyl groups for R⁷, R⁸, and R⁹ include propyl, butyl, pentyl, and hexyl. Preferred alkyl groups for R¹⁰ include methyl, ethyl, propyl, butyl, pentyl, and hexyl.

Preferred species of the phosphonium salt of Formula III include tributylmethylphosphonium hydroxide and tetrabutylphosphonium hydroxide.

### Amount of the Adjuvant

It has been discovered that one or more of the benefits described herein, particularly a reduction in volatility of the auxin herbicide, can in some cases be achieved through the addition of a relatively small proportion of the adjuvant.

Accordingly, in preferred embodiments, the herbicidal mixture comprises an equal or lesser amount of the adjuvant relative to auxin herbicide on a molar basis. For example, the molar ratio of the auxin herbicide to the adjuvant may be greater than 1:1, such as at least about 1.25:1, at least about 1.5:1, at least about 1.75:1, at least about 2:1, at least about 2.5:1, at least about 3:1, at least about 4:1, or at least about 5:1.

In some embodiments, the molar ratio of the auxin herbicide to the adjuvant is no greater than 20:1, no greater than 10:1, no greater than 8:1, no greater than 6:1, no greater than 5:1, no greater than 4:1, no greater than 3:1, or no greater than 2:1. The molar ratio of the auxin herbicide to the adjuvant may fall within a range as defined by any combination of the minimum and maximum values listed above.

For example, the molar ratio of the auxin herbicide to the adjuvant may range from about 1:1 to about 10:1, from about 1:1 to about 5:1, from about 1:1 to about 4:1, from about 1:1 to about 3:1, or from about 1:1 to about 2:1 on a molar basis. In some embodiments, the molar ratio of the auxin herbicide to the adjuvant may range from about 2:1 to about 10:1, from about 2:1 to about 8:1, from about 2:1 to about 5:1, from about 2:1 to about 4:1, or from about 2:1 to about 3:1.

### Auxin Herbicide and Salts Thereof

Auxin herbicides include, for example, 3,6-dichloro-2-methoxybenzoic acid (dicamba); 2,4-dichlorophenoxyacetic acid (2,4-D); 4-(2,4-dichlorophenoxy)butyric acid (2,4-DB); dichloroprop; 2-methyl-4-chlorophenoxyacetic acid (MCPA); 4-(4-chloro-2-methylphenoxy)butanoic acid (MCPB); 4-chlorophenoxyacetic acid; 2,4,5-trichlorophenoxyacetic acid (2,4,5-T); aminopyralid; clopyralid; fluroxypyr; triclopyr; mecoprop; picloram; quinclorac; aminocyclopyrachlor; and mixtures thereof. Salts of these herbicides generally include, for example, the alkali metal salts and organic ammonium salts, which are also referred to as amine salts. Specific salts of auxin herbicides include sodium, potassium, diglycolamine, monoethanolamine, diethanolamine, triethanolamine, dimethylamine, and mixtures thereof.

In some embodiments, the auxin herbicide comprises 2,4-D. In various embodiments, the auxin herbicide comprises dicamba. Some preferred dicamba salts are selected from the group consisting of the diglycolamine salt, monoethanolamine salt, potassium salt, and mixtures thereof. For example, the composition can comprise the monoethanolamine salt of dicamba. As a further example, the composition can comprise the diglycolamine salt of dicamba. As a still further example, the composition can comprise the potassium salt of dicamba. As yet another example, the composition can comprise the sodium salt of dicamba.

Other salts of auxin herbicides include polyamine salts such as those described in United States Patent Application Publication 2012/0184434, the entire disclosure of which is incorporated herein by reference for all relevant purposes. The salts described in US 2012/0184434 include an anionic pesticide, such as dicamba and other auxin herbicides, and a cationic polyamine of formula (A)

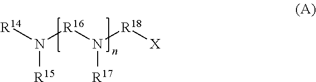

wherein R¹⁴, R¹⁵, R¹⁷, R¹⁹ and R²⁰ are independently H or C₁-C₆-alkyl, which is optionally substituted with OH, R¹⁶ and R¹⁸ are independently C₂-C₄-alkylene, X is OH or NR¹⁹R²⁰, and n is from 1 to 20; or a cationic polyamine of formula (B)

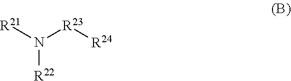

wherein R²¹ and R²² are independently H or C₁-C₆-alkyl, R²³ is C₁-C₁₂-alkylene, and R²⁴ is an aliphatic C₅-C₈ ring system, which comprises either nitrogen in the ring or which is substituted with at least one unit NR²¹R²². Examples of these cationic polyamines include tetraethylenepentamine, triethylenetetramine, diethylenetriamine, pentamethyldiethylenetriamine, N,N,N′,N″,N″-pentamethyl-dipropylenetriamine, N,N-bis(3-dimethylaminopropyl)-N-isopropanolamine, N′-(3-(dimethylamino)propyl)-N,N-dimethyl-1,3-propanediamine, N,N-bis(3-aminopropyl)methylamine, N-(3-dimethylaminopropyl)-N,N-diisopropanolamine, N,N,N′-trimethylaminoethyl-ethanolamine, aminopropylmonomethylethanolamine, and aminoethylethanolamine. Accordingly, in some embodiments, the composition comprises an auxin herbicide salt (e.g. auxin herbicide salt) comprising a cationic polyamine of formula A or B above.

### Agrochemical Components

It has been observed that auxin herbicides such as dicamba may exhibit an increase in volatility when combined with certain classes of agrochemicals and applied under certain conditions. Agrochemicals that have been observed to promote the volatilization of auxin herbicides such as dicamba include, for example, agrochemicals comprising ammonium ions, agrochemicals comprising primary or secondary organic amines, and agrochemicals that act as acidifiers (e.g., by reducing the pH of the composition).

It has been discovered that the adjuvants described herein are effective at controlling or reducing the volatility of auxin herbicides such as dicamba even in the presence of such an agrochemical component that promotes the volatilization of the auxin herbicide. Accordingly, the mixtures and compositions described herein may comprise an agrochemical component comprising one or more agrochemicals that promote the volatilization of the auxin herbicide. As used herein, the ability of an agrochemical to promote the volatilization of the auxin herbicide in a herbicidal formulation can be readily determined using techniques known to those skilled in the art including, but not limited to, a humidome test as described in Example 2 and in “A Method to Determine the Relative Volatility of Auxin Herbicide Formulations” in ASTM publication STP1587 entitled “Pesticide Formulation and Delivery Systems: 35th Volume, Pesticide Formulations, Adjuvants, and Spray Characterization in 2014, published 2016, which is incorporated herein by reference.

For example, mixtures of an auxin herbicide such as dicamba with components comprising ammonium ions have been known to promote the volatilization of the auxin herbicide, and thereby exacerbate problems associated with auxin herbicide volatility. Common components of herbicidal mixtures that comprise ammonium ions include, for example, ammonium salts of co-herbicides (e.g., ammonium glyphosate or ammonium glufosinate), agricultural additives such as ammonium sulfate and other fertilizers and inorganic ammonium-containing water conditioning agents.

Accordingly, the mixtures and compositions described herein may comprise an agrochemical that comprises a source of ammonium ions. It has been discovered that the adjuvants described herein are effective at controlling or reducing the volatility of auxin herbicides even in the presence of a component comprising ammonium ions (i.e., NH₄⁺ ions). This represents a significant advantage because a wide variety of components comprising ammonium ions are commonly used in agriculture, and are commonly incorporated into tank mixtures comprising herbicides.

Non-limiting examples of agrochemicals comprising ammonium ions that may be present in the auxin herbicidal mixtures and compositions described herein include ammonium-containing co-herbicides, including but not limited to ammonium glyphosate and ammonium glufosinate; and ammonium-containing agricultural additives such as fertilizers and ammonium-containing water conditioning agents, including but not limited to ammonium sulfate, ammonium thiosulfate, ammonium oxalate, ammonium nitrate, urea ammonium nitrate, ammonium thiocyanate, ammonium chloride, ammonium phosphate, ammonium isethionate, ammonium lactate, ammonium hydroxide, ammonium bicarbonate, ammonium carbonate, ammonium sulfide and mixtures thereof.

Non-limiting examples of agrochemicals comprising primary or secondary organic amines include the organic amine salts of the various co-herbicides described herein, including but not limited to, the organic amine salts of glyphosate and glufosinate. For example, the agrochemical component can comprise a glyphosate or glufosinate salt selected from the group consisting of the monoethanolamine, n-propylamine, isopropylamine, ethylamine, dimethylamine, ethylenediamine, hexamethylenediamine and trimethylsulfonium salts, and mixtures thereof. In some embodiments, the agrochemical component comprises the isopropylamine salt of glyphosate. In another embodiment, the agrochemical component comprises the dimethylamine salt of glyphosate.

Non-limiting examples of agrochemicals that act as acidifiers include the alkali salts of glyphosate and glufosinate, such as potassium glyphosate, sodium glyphosate, potassium glufosinate, and sodium glufosinate; polycarboxylic acids and hydroxyl acids, such as citric acid, gluconic acid, oxalic acid, malonic acid, succinic acid, malic acid, tartaric acid, fumaric acid, maleic acid, glutaric acid, dimethylglutaric acid, adipic acid, trimethyladipic acid, pimelic acid, tartronic acid, suberic acid, azelaic acid, sebacic acid, 1,12-dodecanedioic acid, 1,13-tridecanedioic acid, glutamic acid, phthalic acid, isophthalic acid, lactic acid, terephthalic acid, or an anhydride, ester, amide, halide, salt or precursor of any of these acids; and fatty acids or agronomically acceptable salts thereof, particularly C₈ to C₁₂ saturated, straight or branched chain fatty acids (e.g., water-soluble, agronomically acceptable salts of pelargonic acid).

Depending upon the particular agrochemical (e.g., herbicidal ammonium salt or water conditioning agent), the concentration in the herbicidal mixture or composition may vary significantly. The concentration of the agrochemical component in the herbicidal mixture is typically at least about 0.01 wt. %, at least about 0.1 wt. %, at least about 1 wt. %, or at least about 5 wt. %.

In some embodiments, the molar ratio of ammonium ions and/or primary or secondary organic amines to auxin herbicide in the herbicidal mixture or composition is at least about 0.01:1, at least about 0.05:1, at least about 0.1:1, at least about 0.2:1, at least about 0.3:1, at least about 0.4:1, at least about 0.5:1, at least about 0.6:1, at least about 0.7:1, at least about 0.8:1, at least about 0.9:1, at least about 1:1, at least about 1.5:1, or at least about 2:1. In some embodiments, the molar ratio of ammonium ions to auxin herbicide in the herbicidal mixture or composition is no greater than 100:1, no greater than 50:1, no greater than 40:1, no greater than 30:1, no greater than 20:1, no greater than 10:1, or no greater than 5:1. The molar ratio of ammonium ions to auxin herbicide in the herbicidal mixture or composition may fall within a range as defined by any combination of the minimum and maximum values listed above.

### Co-Herbicides

As noted above, in various embodiments, the agrochemical component comprises a co-herbicide. In some embodiments, the co-herbicide is an agrochemical that promotes the volatilization of auxin herbicides such as dicamba as described herein. In other embodiments, the co-herbicide is not an agrochemical that promotes the volatilization of the auxin herbicide such as dicamba as described herein.

Co-herbicides include, for example, one or more additional auxin herbicides, acetyl CoA carboxylase (ACCase) inhibitors; acetolactate synthase (ALS) or acetohydroxy acid synthase (AHAS) inhibitors; photosystem II inhibitors; photosystem I inhibitors; protoporphyrinogen oxidase (PPO or Protox) inhibitors; carotenoid biosynthesis inhibitors; enolpyruvyl shikimate-3-phosphate (EPSP) synthase inhibitor; glutamine synthetase inhibitor; dihydropteroate synthetase inhibitor; mitosis inhibitors; 4-hydroxyphenyl-pyruvate-dioxygenase (4-HPPD) inhibitors; auxin transport inhibitors; nucleic acid inhibitors; agriculturally acceptable salts, esters and other derivatives of these herbicides; racemic mixtures and resolved isomers thereof; and combinations thereof.

Specific examples of suitable co-herbicides include acetochlor; acifluorfen; alachlor; atrazine; azafenidin; bifenox; butachlor; butafenacil; carfentrazone-ethyl; diuron; dithiopyr; flufenpyr-ethyl; flumiclorac-pentyl; flumioxazin; fluoroglycofen; fluthiacet-methyl; fomesafen, N-(phosphonomethyl)glycine (glyphosate); DL-phosphinothricin (glufosinate); imazethapyr; lactofen; metazochlor; metolachlor (and S-metolachlor); metribuzin; oxadiargyl; oxadiazon; oxyfluorfen; pretilachlor; propachlor; propisochlor; pyraflufen-ethyl; sulfentrazone; thenylchlor; and agriculturally salts, esters and other derivatives thereof; racemic mixtures and resolved isomers thereof, and combinations thereof.

In some embodiments, the co-herbicide is a photosystem II inhibitor selected from, for example, ametryn, amicarbazone, atrazine, bentazon, bromacil, bromoxynil, chlorotoluron, cyanazine, desmedipham, desmetryn, dimefuron, diuron, fluometuron, hexazinone, ioxynil, isoproturon, linuron, metamitron, methibenzuron, metoxuron, metribuzin, monolinuron, phenmedipham, prometon, prometryn, propanil, pyrazon, pyridate, siduron, simazine, simetryn, tebuthiuron, terbacil, terbumeton, terbuthylazine and trietazine, salts and esters thereof, and mixtures thereof. In another embodiment, the co-herbicide is a 4-HPPD inhibitor selected from, for example, mesotrione, isoxaflutole, benzofenap, pyrazolynate, pyrazoxyfen, sulcotrione, tembotrione, and tropramezone.

In some embodiments, the co-herbicide is a graminicide selected from butroxydim, clethodim, cycloxydim, sethoxydim, tepraloxydim, tralkoxydim, profoxydim, haloxyfop, propaquizafop and the C₁₋₄ alkyl and propargyl esters of clodinafop, cyhalofop, diclofop, fenoxaprop, fluazifop, fluazifop-P, haloxyfop, quizalofop and quizalofop-P (e.g., quizalofop-ethyl or quizalofop-P-ethyl, clodinafop-propargyl, cyhalofop-butyl, diclofop-methyl, fenoxaprop-P-ethyl, fluazifop-P-butyl, haloxyfop-methyl, haloxyfop-R-methyl).

Some preferred co-herbicides include, for example, N-(phosphonomethyl)glycine (glyphosate); DL-phosphinothricin (glufosinate); atrazine; acetochlor; fomesafen; flumioxazin; lactofen; sulfentrazone; metribuzin; clethodim; sethoxydim; metolachlor; alachlor; fenoxaprop; fluazifop; haloxyfop-methyl; paraquat; trialkoxydim; agriculturally acceptable salts or other derivatives of any of these herbicides; and mixtures thereof.

In some embodiments, the co-herbicide includes an additional auxin herbicide. As noted herein, auxin herbicides include dicamba; 2,4-D; 2,4-DB; dichloroprop; MCPA; MCPB; 4-chlorophenoxyacetic acid; 2,4,5-T; aminopyralid; clopyralid; fluroxypyr; triclopyr; mecoprop; picloram; quinclorac; aminocyclopyrachlor; and mixtures thereof.

It has been observed that the volatility of auxin herbicides such as dicamba increases, in some cases, when mixed with a co-herbicide, particularly a co-herbicide that is more acidic in solution (i.e., has the potential to donate a free proton) than the auxin herbicide. For example, co-herbicides with a pKa or first pKa that is less than about 5 have been observed to increase the volatility of some dicamba formulations when mixed. Co-herbicides that have a first pKa less than about 5 include, for example, glyphosate and glufosinate. Nevertheless, herbicidal mixtures containing dicamba and these co-herbicides are desired because of their effectiveness and the development of transgenic crops that are tolerant to both dicamba and certain co-herbicides (e.g., glyphosate). Accordingly, in various preferred embodiments, the co-herbicide is selected from the group consisting of glyphosate, glufosinate, agriculturally acceptable salts, esters or other derivatives thereof and mixtures thereof.

In some embodiments, the co-herbicide comprises one or more salts of glyphosate. Glyphosate salts include mono, di- or tribasic and include ammonium (e.g., mono-, di- or triammonium), alkali metal (e.g., potassium or sodium), sulfonium (e.g., mono-, di- or trimethylsulfonium) and organic ammonium salts of glyphosate. The organic ammonium salts, commonly referred to as amine salts, can comprise aliphatic or aromatic amine salts and can include primary, secondary, tertiary or quaternary amine salts. Representative, non-limiting examples of such organic amine salts include isopropylamine, n-propylamine, ethylamine, dimethylamine, monoethanolamine, ethylenediamine and hexamethylenediamine salts of glyphosate. Accordingly, in some embodiments, the glyphosate salt is selected from the group consisting of the potassium salt, monoammonium salt, diammonium salt, sodium salt, monoethanolamine salt, n-propylamine salt, isopropylamine salt, ethylamine salt, dimethylamine salt, ethylenediamine salt, hexamethylenediamine salt, trimethylsulfonium salt and mixtures thereof (e.g., the potassium salt, monoethanolamine salt, isopropylamine salt, and mixtures thereof). For example, in some embodiments, the co-herbicide comprises glyphosate in the form of the isopropylamine salt.

The alkali salts of glyphosate have been found to be particularly suitable for achieving high herbicidal loadings in glyphosate concentrate compositions. Thus, in some embodiments, the co-herbicide comprises a glyphosate salt comprising an alkali salt (e.g., the potassium and/or sodium salt). In some embodiments, the co-herbicide comprises glyphosate in the form of the potassium salt.

### Monocarboxylic Acids, or Salts Thereof

The herbicidal mixture or compositions described herein can further comprise other additives to control or reduce potential pesticide volatility, including auxin herbicide volatility. For example, as described in U.S. Application Publication Nos. US 2014/0128264 and US 2015/0264924, which are incorporated herein by reference, additives to control or reduce potential pesticide volatility include monocarboxylic acids, or salts thereof (e.g., acetic acid and/or an agriculturally acceptable salt thereof. Representative monocarboxylic acids and monocarboxylates generally comprise a hydrocarbon or unsubstituted hydrocarbon selected from, for example, unsubstituted or substituted, straight or branched chain alkyl (e.g., C₁-C₂₀ alkyl such as methyl, ethyl, n-propyl, isopropyl, etc.); unsubstituted or substituted, straight or branched chain alkenyl (e.g., C₂-C₂₀ alkyl such as ethenyl, n-propenyl, isopropenyl, etc.); unsubstituted or substituted aryl (e.g., phenyl, hydroxyphenyl, etc.); or unsubstituted or substituted arylalkyl (e.g., benzyl). In particular, the monocarboxylic acid can be selected from the group consisting of formic acid, acetic acid, propionic acid, and benzoic acid. The monocarboxylate salt can be selected from the group consisting of formate salts, acetate salts, propionate salts, and benzoate salts. The monocarboxylate salts can include, for example, alkali metal salts selected from sodium and potassium. Preferred monocarboxylate salts include sodium acetate and potassium acetate.

The molar ratio of the pesticide (e.g., auxin herbicide) to the monocarboxylic acid, or monocarboxylate thereof, is typically from about 1:10 to about 10:1, from about 1:5 to about 5:1, from about 3:1 to about 1:3, or from about 2:1 to about 1:2 (e.g., about 1:1).

In various herbicidal concentrate compositions of the present invention, the concentration of monocarboxylic acid and/or salt thereof can be from about 0.25% to about 25%, from about 1% to about 20%, from about 2% to about 15%, from about 2% to about 10%, or from about 5% to about 15% by weight of the concentrate composition.

### Surfactants

The herbicidal composition or mixture may further comprise one or more surfactants to enhance the herbicidal effectiveness of the auxin herbicide and/or optional co-herbicide. Surfactants are may be included in the herbicidal mixtures to facilitate herbicide retention, uptake and translocation into the plant foliage and thereby enhance herbicidal effectiveness. A weight ratio (a.e.) of total herbicide to surfactant generally ranges from about 1:1 to about 20:1, from about 2:1 to about 10:1, or from about 3:1 to about 8:1.

Some or all of the surfactant of the herbicidal composition or mixture may be supplied from an adjuvant composition described herein. Some or all of the surfactant may also be incorporated from a standalone surfactant composition, auxin herbicidal concentrate or dilution thereof, and/or co-herbicide concentrate or dilution thereof (when a co-herbicide is added).

The surfactant may include one or more surfactants known in the art. Known surfactants for use in the present invention include alkoxylated tertiary etheramines, alkoxylated quaternary etheramines, alkoxylated etheramine oxides, alkoxylated tertiary amines, alkoxylated quaternary amines, alkoxylated polyamines, sulfates, sulfonates, phosphate esters, alkylpolysaccharides, alkoxylated alcohols, amidoalkylamines and combinations thereof.

Examples of alkoxylated tertiary etheramine surfactants include, any of the TOMAH E series surfactants, such as TOMAH E-14-2 (bis-(2-hydroxyethyl) isodecyloxypropylamine), TOMAH E-14-5 (poly(5)oxyethylene isodecyloxypropylamine), TOMAH E-17-2, TOMAH E-17-5 (poly(5)oxyethylene isotridecyloxypropyl amine), TOMAH E-19-2, TOMAH E-18-2, TOMAH E-18-5 (poly(5)oxyethylene octadecylamine), TOMAH E-18-15, TOMAH E-19-2 (bis-(2-hydroxyethyl) linear alkyloxypropylamine), TOMAH E-S-2, TOMAH E-S-15, TOMAH E-T-2 (bis-(2-hydroxyethyl) tallow amine), TOMAH E-T-5 (poly(5)oxyethylene tallow amine), and TOMAH E-T-15 (poly(15)oxyethylene tallow amine), all of which are available from Air Products and Chemicals, Inc. Specific alkoxylated quaternary etheramine surfactants for use in the herbicidal mixtures and compositions described herein include, for example, TOMAH Q-14-2, TOMAH Q-17-2, TOMAH Q-17-5, TOMAH Q-18-2, TOMAH Q-S, TOMAH Q-S-80, TOMAH Q-D-T, TOMAH Q-DT-HG, TOMAH Q-C-15, and TOMAH Q-ST-50, all of which are available from Air Products and Chemicals, Inc.

Examples of alkoxylated etheramine oxide surfactants include any of the TOMAH AO series of surfactants, such as TOMAH AO-14-2, TOMAH AO-728, TOMAH AO-17-7, TOMAH AO-405, and TOMAH AO-455, all of which are available from Air Products and Chemicals, Inc. Alkoxylated tertiary amine oxide surfactants include, for example, any of the AROMOX series of surfactants, including AROMOX C/12, AROMOX C/12W, AROMOX DMC, AROMOX DM16, AROMOX DMHT, and AROMOX T/12 DEG, all of which are available from Akzo Nobel.

Alkoxylated tertiary amine surfactants include, for example, ETHOMEEN T/12, ETHOMEEN T/20, ETHOMEEN T/25, ETHOMEEN T/30, ETHOMEEN T/60, ETHOMEEN C/12, ETHOMEEN C/15, and ETHOMEEN C/25, all of which are available from Akzo Nobel. Alkoxylated quaternary amine surfactants include, for example, ETHOQUAD T/12, ETHOQUAD T/20, ETHOQUAD T/25, ETHOQUAD C/12, ETHOQUAD C/15, and ETHOQUAD C/25, all of which are available from Akzo Nobel.

Alkoxylated polyamine surfactants include, for example, ethoxylates of ADOGEN 560 (N-coco propylene diamine) containing an average of from 2EO to 20EO, for example, 4.8, 10 or 13.4EO; ethoxylates of ADOGEN 570 (N-tallow propylene diamine) containing an average of form 2EO to 20EO, for example, 13EO; and ethoxylates of ADOGEN 670 (N-tallow propylene triamine) containing an average of from 3EO to 20EO, for example, 14.9EO, all of which are available from Witco Corp. Other polyamine surfactants for use in the present invention include Triamine C, Triamine OV, Triamine T, Triamine YT, Triameen Y12D, Triameen Y12D-30, Tetrameen OV, Tetrameen T3, all of which are available from Akzo Nobel.

Sulfate surfactants include, for example, sodium nonylphenol ethoxylate sulfate (4 EO), sodium nonylphenol ethoxylate sulfate (10 EO), WITCOLATE 1247H, WITCOLATE 7093, WITCOLATE 7259, WITCOLATE 1276, WITCOLATE LES-60A, WITCOLATE LES-60C, WITCOLATE 1050, WITCOLATE WAQ, WITCOLATE D-51-51 and WITCOLATE D-51-53, all of which are available from Witco Corp. Sulfonate surfactants include, for example, WITCONATE 93S, WITCONATE NAS-8, WITCONATE AOS, WITCONATE 60T and WITCONATE 605, all of which are available from Witco Corp.

Phosphate esters of alkoxylated alcohol surfactants include, for example, EMPHOS CS-121, EMPHOS PS-400, and WITCONATE D-51-29, available from Witco Corp. Other examples include the PHOSPHOLAN series surfactants available from Akzo Nobel.

Alkylpolysaccharides are yet another suitable class of surfactants. Examples of alkylpolysaccharide surfactants include alkylpolyglucoside (APG) surfactants such as AGNIQUE PG8107-G (AGRIMUL PG 2067) available from BASF. Other representative alkylpolysaccharide surfactants include APG 225, APG 325, APG 425, APG 625, GLUCOPON 600, PLANTAREN 600, PLANTAREN 1200, PLANTAREN 1300, PLANTAREN 2000, AGRIMUL PG 2076, AGRIMUL PG 2067, AGRIMUL PG 2072, AGRIMUL PG 2069, AGRIMUL PG 2062, AGRIMUL PG 2065, and BEROL AG 6202.

Alkoxylated alcohol surfactants include, for example, EMULGIN L, PROCOL LA-15 (from Protameen); BRIJ 35, BRIJ 56, BRIJ 76, BRIJ 78, BRIJ 97, BRIJ 98 (from Sigma Chemical Co.); NEODOL 25-12 and NEODOL 45-13 (from Shell); HETOXOL CA-10, HETOXOL CA-20, HETOXOL CS-9, HETOXOL CS-15, HETOXOL CS-20, HETOXOL CS-25, HETOXOL CS-30, PLURAFAC A38 and PLURAFAC LF700 (from BASF); ST-8303 (from Cognis); AROSURF 66 E10 and AROSURF 66 E20 (from Witco/Crompton); ethoxylated (9.4 EO) tallow, propoxylated (4.4 EO) tallow and alkoxylated (5-16 EO and 2-5 PO) tallow (from Witco/Crompton). Other examples are SURFONIC NP95 and the SURFONIC LF-X series from Huntsman Chemical Co. and the TERGITOL series from Dow.

In some instances, one or more amidoalkylamine surfactants may be included to enhance the stability of the herbicidal composition or mixture. Examples of APA surfactants include ARMEEN APA 2, ARMEEN APA 6, ARMEEN APA 8, ARMEEN APA 10, ARMEEN APA 12, ACAR 7051, ACAR 7059 and ADSEE C80W (Akzo Nobel).

### Further Components

The herbicidal composition or mixture may further comprise other conventional adjuvants or excipients known to those skilled in the art. Hence, the herbicidal composition or mixture may further comprise one or more additional ingredients selected from, without limitation, foam-moderating agents, preservatives or anti-microbials, antifreeze agents, solubility-enhancing agents, dyes, and thickening agents.

The herbicidal composition or mixture may further comprise drift control agents. Drift control agents suitable for the practice of the present invention are known to those skilled in the art and include GARDIAN, GARDIAN PLUS, DRI-GARD, and PRO-ONE XL available from Van Diest Supply Co.; COMPADRE, available from Loveland Products, Inc.; BRONC MAX EDT, BRONC PLUS DRY EDT, EDT CONCENTRATE, and IN-PLACE available from Wilbur-Ellis Company; STRIKE ZONE DF available from Helena Chemical Co.; INTACT and INTACT XTRA available from Precision Laboratories, LLC; and AGRHO DR 2000 and AGRHO DEP 775 available from the Solvay Group. Suitable drift control agents include, for example, guar-based (e.g., containing guar gum or derivatized guar gum) drift control agents. Various drift control products may also contain one or more water conditioning agent in combination with the drift control agent(s).

### Compositions Comprising Auxin Herbicide and Hydroxide Salt Adjuvants

As discussed above, the herbicidal mixtures described herein are effective at controlling or reducing the volatility of auxin herbicides such as dicamba even in the presence of a component comprising one or more agrochemicals that promote the volatilization of the auxin herbicide. It has also been discovered that such compositions may exhibit reduced volatility and improved stability even at high concentrations of auxin herbicide, and/or in the presence of high concentrations of a co-herbicide.

Accordingly, provided herein is an herbicidal composition comprising an auxin herbicide (e.g., dicamba), in the form of a salt thereof comprising a first cation; an agrochemical component comprising one or more agrochemicals that promote the volatilization of the auxin herbicide; and an adjuvant comprising a cation selected from the group consisting of:

(a) a quaternary ammonium cation of Formula Ia

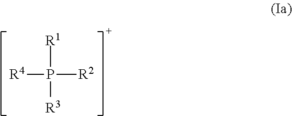

wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;

(b) a nitrogen heterocycle cation of Formula IIa

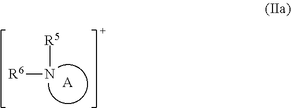

wherein A is a 5 or 6-membered heterocyclic ring; R⁵ is a C₁-C₂₀ alkyl; R⁶ is hydrogen or a C₁-C₆ alkyl;

(c) a phosphonium cation of Formula IIIa

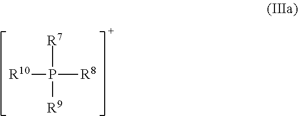

wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13. The cations of Formulas Ia, IIa and IIIa may be used in combination.

In the ammonium cation of Formula Ia, R¹, R², R³, and R⁴ may each be selected as described above with respect to R¹, R², R³, and R⁴ in Formula I. In the nitrogen heterocycle cation of Formula IIa, R⁵, R⁶, and A may each be selected as described above with respect to R⁵, R⁶, and A in Formula II. In the ammonium cation of Formula IIIa, R⁷, R⁸, R⁹, and R¹⁰ may each be selected as described above with respect to R⁷, R⁸, R⁹, and R¹⁰ in Formula III.

Preferred species of the quaternary ammonium cation of Formula Ia include tributylmethylammonium and tetrabutylammonium.

Preferred species of the nitrogen heterocycle cation of Formula IIa include 1-butyl-1-methyl-pyrrolidinium, 1-ethyl-3-methylimidazolium, 1-butyl-3-methylimidazolium, 1-methyl-3-octylimidazolium, and cetylpyridinium.

Preferred species of the phosphonium cation of Formula IIIa include tributylmethylphosphonium and tetrabutylphosphonium.

For example, provided herein is a herbicidal composition comprising an auxin herbicide, in the form of a salt thereof comprising a first cation; an agrochemical component comprising ammonium glyphosate; and an adjuvant comprising a cation as described above.

Also provided herein is a herbicidal composition comprising auxin herbicide, in the form of a salt thereof comprising a first cation; an agrochemical component comprising ammonium glufosinate; and an adjuvant comprising a cation as described above.

Also provided herein is a herbicidal composition comprising auxin herbicide, in the form of a salt thereof comprising a first cation; an agrochemical component comprising ammonium sulfate; and an adjuvant comprising a cation as described above.

In some embodiments, the composition is an herbicidal concentrate as described herein, and comprises auxin herbicide in a concentration of at least 50 grams per liter on an acid equivalent (a.e.) basis. In other embodiments, the composition is an herbicidal application mixture suitable for application to unwanted plants.

The herbicidal composition may be prepared, for example, by a method as described above.

The herbicidal composition may an auxin herbicide in the form of a salt as described in detail above. The herbicidal composition may also comprise an agrochemical component as described in detail above. For example, the agrochemical component may comprise one or more co-herbicides, surfactants, agrochemicals that promote the volatilization of the auxin herbicide (e.g., ammonium ions), or further components as described in detail above.

The herbicidal composition preferably comprises an equal or lesser amount of the cation adjuvant relative to the auxin herbicide on a molar basis and the molar ratio of auxin herbicide to the cation adjuvant may generally be selected as described above.

Also provided herein is a herbicidal composition comprising an auxin herbicide (e.g., dicamba), in the form of a salt thereof comprising a cation; and an agrochemical component comprising one or more agrochemicals that promote the volatilization of the auxin herbicide and comprising a source of ammonium ions as described herein, wherein the cation is selected from the group consisting of:

(a) a quaternary ammonium cation of Formula Ia

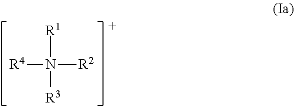

wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;

(b) a nitrogen heterocycle cation of Formula IIa

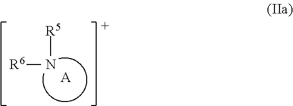

wherein A is a 5 or 6-membered heterocyclic ring; R⁵ is a C₁-C₂₀ alkyl; R⁶ is hydrogen or a C₁-C₆ alkyl;

(c) a phosphonium cation of Formula IIIa

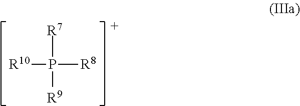

wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof. The herbicidal composition may comprise one or more of the agrochemical components as described in detail above.

### Herbicide Concentration

The herbicidal compositions described herein may be in the form of an herbicidal concentrate, and may comprise the auxin herbicide in a concentration of at least about 50 grams per liter on an acid equivalent (a.e.) basis. For example, the composition or mixture may comprise an auxin herbicide (e.g., dicamba) in a concentration of at least about 75 grams a.e. per liter, at least about 100 grams a.e. per liter, at least about 120 grams a.e. per liter, at least about 140 grams a.e. per liter, at least about 160 grams a.e. per liter, at least about 180 grams a.e. per liter, at least about 200 grams a.e. per liter, at least about 220 grams a.e. per liter, at least about 240 grams a.e. per liter, at least about 280 grams a.e. per liter, at least about 300 grams a.e. per liter, at least about 320 grams a.e. per liter, at least about 360 grams a.e. per liter, at least about 400 grams a.e. per liter, at least about 420 grams a.e. per liter, at least about 450 grams a.e. per liter, or at least about 500 grams a.e. per liter.

The herbicidal compositions described herein may be in the form of an aqueous herbicidal concentrate. Alternatively, the herbicidal compositions described herein may be in the form of a solid herbicidal concentrate.

When the herbicidal composition is in the form of an herbicidal concentrate comprising a co-herbicide, the total herbicide concentration may be at least about 240 grams per liter on an acid equivalent (a.e.) basis. For example, the total herbicide concentration may be at least about 280 grams a.e. per liter, at least about 300 grams a.e. per liter, at least about 320 grams a.e. per liter, at least about 360 grams a.e. per liter, at least about 400 grams a.e. per liter, at least about 420 grams a.e. per liter, at least about 450 grams a.e. per liter, or at least about 500 grams a.e. per liter.

Alternatively, the herbicidal compositions described herein may be in the form of an application mixture, and may comprise an auxin herbicide (e.g., dicamba) in a concentration of from about 0.25 wt. % a.e. to about 6 wt. % a.e., from about 0.25 wt. % a.e. to about 4 wt. % a.e., or from about 0.5 wt. % a.e. to about 2 wt. % a.e. In these embodiments, the concentration of the optional co-herbicide is typically from about 0.5 wt. % a.e. to about 8 wt. % a.e., from about 1 wt. % a.e. to about 6 wt. % a.e., or from about 1 wt. % a.e. to about 4 wt. % a.e.

When a co-herbicide is present, the herbicidal compositions and mixtures described herein generally include relatively equal proportions or an excess of the co-herbicide to auxin herbicide on an acid equivalent basis. For example, the acid equivalent weight ratio of co-herbicide to auxin herbicide may range from about 1:1 to about 5:1, from about 1:1 to about 3:1, from about 1.5:1 to about 3:1, from about 1.5:1 to about 2.5:1, or from about 1.5:1 to about 2:1. In some embodiments, the acid equivalent weight ratio of co-herbicide to auxin herbicide (e.g., dicamba) is about 1.5:1, about 2:1, or about 3:1.

### Methods of Preparing Herbicidal Concentrate Compositions

As noted, the present invention also provides for methods of preparing the herbicidal concentrate compositions described herein.

For example, provided herein is a method of preparing an herbicidal concentrate composition comprising an auxin herbicide (e.g., dicamba), wherein the method comprises combining the auxin herbicide acid (e.g., dicamba acid), a neutralizing base comprising a first cation, and an adjuvant comprising a hydroxide salt comprising a second cation.

The herbicidal concentrate composition may comprise the auxin herbicide in a concentration as described herein (e.g., a concentration of at least about 50 grams a.e. per liter).

The first cation may be selected as generally described above, so that the reaction of the auxin herbicide acid and the neutralizing base produces an auxin herbicide salt as described above. Non-limiting examples of suitable first cations include sodium, potassium, monoethanolammonium, diethanolammonium, isopropylammonium, diglycolammonium, and dimethylammonium. For example, the first cation can be monoethanolammonium. Alternatively, the first cation can be potassium. As a further example, the first cation can be dimethylammonium. As a further example, the first cation can be diglycolammonium.

Those skilled in the art can select a suitable neutralizing base that comprises the first cation. Non-limiting examples of suitable neutralizing bases include hydroxide and halide salts comprising the first cation.

The neutralizing base may be added in an amount sufficient to neutralize all or only a portion of the auxin herbicide acid. For example, the neutralizing base may be added in an amount sufficient to neutralize at least about 5%, at least about 10%, at least about 20%, at least about 30%, at least about 40%, at least about 50%, at least about 60%, at least about 70%, at least about 80%, at least about 90%, or at least about 95% of the auxin herbicide acid on a molar basis. In some embodiments, the neutralizing base is added in an amount sufficient to neutralize substantially all of the auxin herbicide acid. In other embodiments, the neutralizing base is added in an amount sufficient to neutralize no more than about 10%, no more than about 20%, no more than about 30%, no more than about 40%, no more than about 50%, no more than about 60%, no more than about 70%, no more than about 80%, no more than about 90%, or no more than about 95% of the auxin herbicide acid on a molar basis.

The auxin herbicide acid, neutralizing base, and adjuvant can be combined in any order. For example, the auxin herbicide acid may first be combined with the neutralizing base, followed by the adjuvant. Alternatively, the auxin herbicide acid may first be combined with the adjuvant, followed by the neutralizing base.

The herbicidal composition may also comprise an agrochemical component as described in detail above. For example, the agrochemical component may comprise one or more co-herbicides, surfactants, agrochemicals that promote the volatilization of the auxin herbicide (e.g., ammonium ions), or further components as described in detail above.

### Methods of Preparing Herbicidal Application Mixtures

In various embodiments, the method comprises combining the auxin herbicide, the agrochemical component, and the adjuvant as described herein in a liquid medium such as water. In various embodiments, one or more surfactants are included in the herbicidal mixture. The herbicidal mixtures may be prepared from various concentrates. For example, in some embodiments, the herbicidal mixture is a concentrate composition that is prepared by combining a premix concentrate composition comprising the auxin herbicide and an optional co-herbicide with the adjuvant composition. An application mixture may be prepared by diluting the concentrate composition with water or other solvent as desired. Any of the concentrate compositions described herein may be diluted with water or other solvent before, during, or after the preparation process.

Also provided herein is a method of preparing an herbicidal tank mixture, wherein the method comprises combining an auxin herbicide, in the form of a salt thereof comprising a cation; and an agrochemical component comprising one or more agrochemicals that promote the volatilization of the auxin herbicide and comprising a source of ammonium ions as described herein, wherein the cation is selected from the group consisting of:

(a) a quaternary ammonium cation of Formula Ia

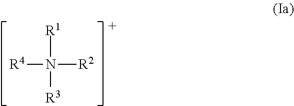

wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;

(b) a nitrogen heterocycle cation of Formula IIa

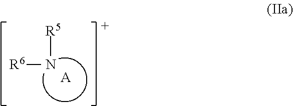

wherein A is a 5 or 6-membered heterocyclic ring; R⁵ is a C₁-C₂₀ alkyl; R⁶ is hydrogen or a C₁-C₆ alkyl;

(c) a phosphonium cation of Formula IIIa

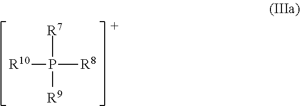

wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof.

### Compositions Comprising Mixed Auxin Herbicide Salts

Also provided herein is an herbicidal composition comprising a first auxin herbicide salt (e.g., a first dicamba salt) comprising a first cation, and a second auxin herbicide salt (e.g., a second dicamba salt) comprising a second cation, and a further component comprising ammonium ions; wherein the second cation is selected from the group consisting of:
(a) a quaternary ammonium cation of Formula Ia

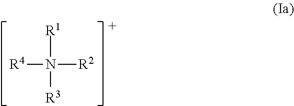

wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;

(b) a nitrogen heterocycle cation of Formula IIa

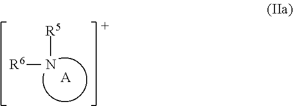

wherein A is a 5 or 6-membered heterocyclic ring; R⁵ is a C₁-C₂₀ alkyl; R⁶ is hydrogen or a C₁-C₆ alkyl;

(c) a phosphonium cation of Formula IIIa

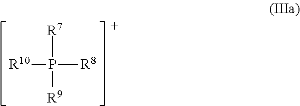

wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13. In some embodiments, the first cation can be at least partially derived from the reaction of auxin herbicide acid and a base (e.g., the adjuvant comprising a hydroxide salt).

In some embodiments, the composition comprises the auxin herbicide in a concentration of at least 240 grams per liter on an acid equivalent (a.e.) basis.

In the ammonium cation of Formula Ia, R¹, R², R³, and R⁴ may each be selected as described above with respect to R¹, R², R³, and R⁴ in Formula I. In the nitrogen heterocycle cation of Formula IIa, R⁵, R⁶, and A may each be selected as described above with respect to R⁵, R⁶, and A in Formula II. In the ammonium cation of Formula IIIa, R⁷, R⁸, R⁹, and R¹⁰ may each be selected as described above with respect to R⁷, R⁸, R⁹, and R¹⁰ in Formula III.

Preferred species of the quaternary ammonium cation of Formula Ia include tributylmethylammonium and tetrabutylammonium.

Preferred species of the nitrogen heterocycle of Formula IIa include 1-butyl-1-methyl-pyrrolidinium, 1-ethyl-3-methylimidazolium, 1-butyl-3-methylimidazolium, 1-methyl-3-octylimidazolium, and cetylpyridinium.

Preferred species of the phosphonium cation of Formula IIIa include tributylmethylphosphonium and tetrabutylphosphonium.

In preferred embodiments, the second auxin herbicide salt is selected from the group consisting of tributylmethylammonium, tetrabutylammonium, tributylmethylphosphonium, and tetrabutylphosphonium.

Generally, the second auxin herbicide salt may comprise any agronomically acceptable salt known in the art, including those auxin salts discussed above with respect to methods of preparing herbicidal mixtures. For example, the second auxin herbicide salt may comprise a sodium, potassium, monoethanolamine, diethanolamine, isopropylamine, diglycolamine, or dimethylamine salt.

In a preferred embodiment, the second cation is tetrabutylammonium and the first cation is selected from the group consisting of potassium, sodium, monoethanolamine, and diglycolamine. For example, in some embodiments, the second cation is tetrabutylammonium and the first cation is potassium or sodium. In other embodiments, the second cation is tetrabutylammonium and the first cation is diglycolamine.

The herbicidal composition may comprise one or more co-herbicides, surfactants, components comprising ammonium ions, or further components as described in detail above.

In some embodiments, the herbicidal composition includes an equal or lesser proportion of the second cation to the first cation on a molar basis. More preferably, the herbicidal composition includes a relatively equal proportion of the second cation to the first cation on a molar basis. For example, the molar ratio of the second cation to the first cation may range from about 1:10 to about 10:1, from about 1:4 to about 4:1, from about 1:3 to about 3:1, or from about 1:2 to about 2:1. In some embodiments, the molar ratio of the second cation to the first cation is about 1:1.

### Methods of Application

The compositions, methods, and mixtures described herein are effective in reducing auxin herbicide (e.g., dicamba) volatility. As such, provided herein is a method of reducing off-site movement of auxin herbicide following application of an herbicidal mixture. The method comprises combining applying an herbicidal mixture comprising an auxin herbicide (e.g., dicamba) and an adjuvant comprising one or more salts of Formulas I, II, and III as previously described to the foliage of one or more plants.

In accordance with the methods described herein, the herbicidal mixture may be applied to the foliage of unwanted plants as a spray application mixture by methods known in the art. The application mixture is applied to the foliage of a plant or plants at an application rate sufficient to give a commercially acceptable rate of weed control. Depending on plant species and growing conditions, the period of time required to achieve a commercially acceptable rate of weed control can be as short as a week or as long as three weeks, four weeks or 30 days. The application rate is usually expressed as amount of herbicide per unit area treated, e.g., grams acid equivalent per hectare (g a.e./ha) and can readily be determined by those skilled in the art.

The compositions and methods described herein are particularly suited for application to transgenic plants having certain herbicide tolerance traits. For example, an application mixture as described herein comprising a dicamba salt would be especially suited for applying to the foliage of dicamba-susceptible plants growing in and/or adjacent to a field of crop plants comprising transgenic crop plants having a dicamba tolerance trait. Further, an application mixture as described herein comprising dicamba and a co-herbicide comprising glyphosate or glufosinate (or salts thereof) would be especially suited for applying to the foliage of auxin-susceptible plants and plants susceptible to the co-herbicide growing in and/or adjacent to a field of crop plants comprising transgenic crop plants having stacked dicamba tolerance trait and a glyphosate or glufosinate tolerance trait, respectively.

The application mixture as described herein can be applied pre-planting of the crop plant, such as from about 2 to about 3 weeks before planting auxin-susceptible crop plants or crop plants not having an auxin herbicide tolerance trait. Crop plants that are not susceptible to auxin herbicides, such as corn, or plants having auxin tolerance and co-herbicide tolerance traits typically have no pre-planting restriction. The application mixture can be applied immediately before planting such crops, at planting, or post-emergence to such crop plants to control auxin-susceptible weeds and co-herbicide-susceptible weeds in a field of the crop plants.

### EXAMPLES

The following non-limiting examples are provided to further illustrate the present invention.

### Example 1: Preparation of Solution Concentrates

Portions of tetrabutylammonium (TBA) dicamba (64 g) and tetrabutylphosphonium (TBP) dicamba (67 g) were weighed and placed into 4 oz. glass jars. Water was added to each to a final mass of 100 g. The resulting concentrate was stirred using a magnetic stir bar until all solid material was homogenously dispersed, resulting in transparent orange concentrate.

Additional concentrates containing TBA dicamba and TBP dicamba were prepared. However, in these mixtures a dispersion agent (EMULPON CO-360) or a surfactant (AGNIQUE PG 8107-U) was added before the addition of water, to a final mass of 5% by weight in each case. The resulting concentrates containing the surfactant were similar in appearance to the concentrates without a surfactant. The concentrates containing the dispersion agent were brown and transparent.

### Example 2: Humidome Study

Compositions comprising glyphosate and dicamba were prepared using the following procedure. The glyphosate component was weighed and dissolved in water, followed by addition of the dicamba component. The final concentration of dicamba was 1.2 wt. % a.e., and the final concentration of glyphosate was 2.4 wt. % a.e. in each composition. The glyphosate component of each composition was either CONTROLMAX, which is an ammonium glyphosate product available from Monsanto Co. or POWERMAX, which is a potassium glyphosate product also available from Monsanto Co. A dispersion agent (EMULPON CO-360) or a surfactant (AGNIQUE PG 8107-U) was added to select compositions as shown in the table below. Ammonium sulfate (AMS) was also added to select compositions as indicated. In compositions containing AMS, the AMS was added first from a 10% AMS in water concentrate, followed by addition of glyphosate, then water, and finally the dicamba.

The pH of selected compositions was adjusted as shown on Table 1. These compositions were prepared as previously described, and then the pH was adjusted with either sulfuric acid or ammonium hydroxide to the stated number.

In general, the compositions were slightly hazy, with formulations containing dispersant being less translucent and formulations containing surfactant being more transparent. The compositions containing glyphosate in combination with TBP dicamba exhibited some flocculation and/or precipitation.

The dicamba volatility from each composition was measured by the procedure described in “A Method to Determine the Relative Volatility of Auxin Herbicide Formulations” in ASTM publication STP1587 entitled “Pesticide Formulation and Delivery Systems: 35th Volume, Pesticide Formulations, Adjuvants, and Spray Characterization in 2014, published 2016, which is incorporated herein by reference. The general procedure is described briefly below.

Humidomes obtained from Hummert International (Part Nos 14-3850-2 for humidomes and 11-3050-1 for 1020 flat tray) were modified by cutting a 2.2 cm diameter hole on one end approximately 5 cm from the top to allow for insertion of a glass air sampling tube (22 mm OD) containing a polyurethane foam (PUF) filter. The sampling tube was secured with a VITON o-ring on each side of the humidome wall. The air sampling tube external to the humidome was fitted with tubing that was connected to a vacuum manifold immediately prior to sampling.

The flat tray beneath the humidome was filled with 1 liter of sifted dry or wet 50/50 soil (50% Redi-Earth and 50% US 10 Field Soil) to a depth of about 1 cm. A track sprayer was used to apply the compositions at a dicamba application rate of 1.0 lb/A a.e. at 10 gallons per acre (GPA) onto the soil of each humidome.

The flat tray bottom containing the auxin herbicide formulation on soil was covered with the humidome lid and the lid was secured with clamps. The growth chambers were set at 35° C. and 40% relative humidity (RH). The assembled humidomes were placed in a temperature and humidity controlled environment and connected to a vacuum manifold through the air sampling line. Air was drawn through the humidome and PUF at a rate of 2 liters per minute (LPM) for 24 hours at which point the air sampling was stopped. The humidomes were then removed from the controlled environment and the PUF filter was removed. The PUF filter was extracted with 20 mL of methanol and the solution was analyzed for the auxin herbicide concentration using LC-MS methods known in the art.

The results of the humidome study are shown in Table 1 below. The results are presented as a percent volatility reduction relative to the volatility measured from application of a tank mix of CLARITY (diglycolamine dicamba available from BASF) and CONTROLMAX (ammonium glyphosate).

TABLE 1

| Composition | Volatility Reduction |
|---|---|
| CLARITY + CONTROLMAX | 0.0% |
| TBP Dicamba | 99.7% |
| TBP Dicamba + CONTROLMAX | 98.9% |
| TBP Dicamba + | 99.7% |
| AGNIQUE PG 8107-U | |
| TBP Dicamba + CONTROLMAX + | 98.6% |
| AGNIQUE PG 8107-U | |
| TBA Dicamba | 99.5% |
| TBA Dicamba + CONTROLMAX | 97.1% |
| TBA Dicamba + EMULPON CO-360 | 99.6% |
| TBA Dicamba + CONTROLMAX + | 97.4% |
| EMULPON CO-360 | |
| TBA Dicamba + CONTROLMAX (pH = 2) | 93.0% |
| TBA Dicamba + CONTROLMAX (pH = 7) | 96.8% |
| TBA Dicamba + CONTROLMAX (pH = 9) | 97.3% |
| TBA Dicamba + POWERMAX | 98.5% |
| TBA Dicamba + POWERMAX + 0.1% | 98.7% |
| Ammonium Sulfate | |
| TBA Dicamba + POWERMAX + 1% | 97.5% |
| Ammonium Sulfate | |
| TBA Dicamba + CONTROLMAX (sample | 97.0% |
| prepared 24 h in advance of spray) | |

### Example 3: Evaluation of Physical Stability

Compositions were prepared in accordance in Example 2. POWERMAX (potassium glyphosate) was used to provide for the glyphosate component. One series of compositions had a dicamba concentration of 1.2 wt. % a.e. and a glyphosate concentration of 2.4 wt. % a.e. Another series of compositions had a compositions had a dicamba concentration of 0.6 wt. % a.e. and a glyphosate concentration of 1.2 wt. % a.e. These compositions were evaluated for physical stability.

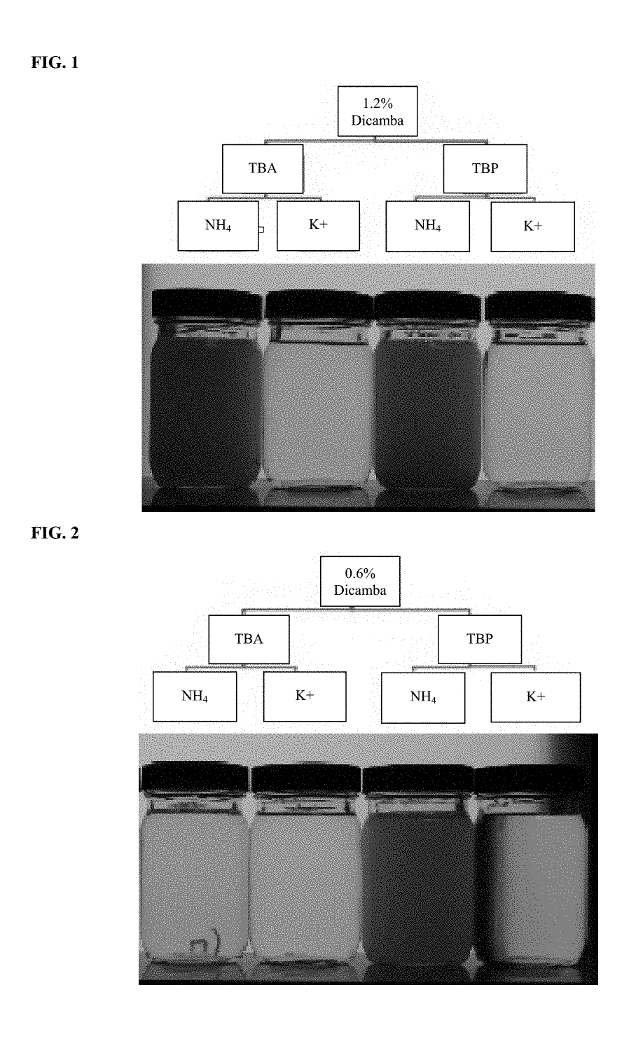

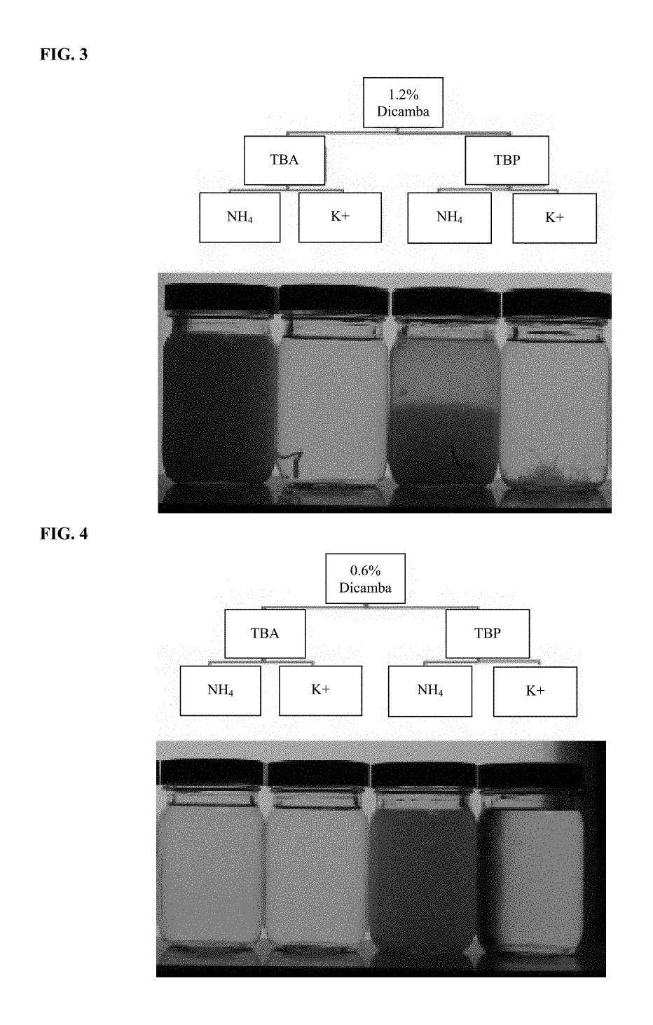

Images of the compositions were taken immediately after preparation (FIGS. 1 and 2) and after sitting at room temperature for 3 days (FIGS. 3 and 4). Note that compositions were not were not agitated before the image was taken at 3 days. In general, the compositions at lower concentrations of potassium glyphosate and TBA dicamba exhibited greater physical stability.

### Example 4: Volatility Control

A composition containing a combination of tetrabutylammonium (TBA) and dicamba was made in situ by combining sodium dicamba and tetrabutylammonium chloride. CONTROLMAX (ammonium glyphosate) was also added to the composition. A second composition was prepared by mixing TBA dicamba (previously prepared and isolated), CONTROLMAX and NaCl (a byproduct from the in situ reaction described above). These compositions were subjected to volatility testing according to the humidome procedure describe in Example 2.

The results of the volatility testing are shown in Table 2 below. The results are presented as a percent volatility reduction relative to the volatility measured from application of a tank mix of CLARITY (diglycolamine dicamba) and CONTROLMAX (ammonium glyphosate).

Compared to the composition prepared from isolated material, the in situ TBA dicamba exhibited a slight decrease in volatility control, but still provided excellent overall control. This finding is important because previous hypotheses implied that mixtures of dicamba and adjuvant needed to be isolated before formulation, which would be expected to greatly increased the complexity of the manufacturing process.

TABLE 2

| Composition | % Volatility Control |
|---|---|
| TBA Dicamba (in situ) + | 93.0% |
| CONTROLMAX | |
| TBA Dicamba (isolated) + | 94.5% |
| CONTROLMAX + NaCl | |

### Example 5: Effect of Cation Properties on Volatility Control

Various ammonium cations were assessed for volatility control. The experiments explored the effect on the degree of substitution on the ammonium cation (i.e., primary, tertiary, quaternary) and hydrophobicity (carbon content) on the volatility control provided by the cation.

The results of these experiments are shown in Table 3. The results show that cations having greater hydrophobicity (i.e., more carbon atoms) generally exhibit better volatility control. Also, for cations with similar hydrophobicity, a higher degree of substitution provides for greater volatility control (i.e., quaternary >tertiary >primary). Further, without being bound by theory, a minimum carbon chain length may be required to achieve a significant volatility reduction. For example, tripropylammonium exhibits no significant control, but tributylammonium does. Additionally, the total number of carbon atoms (e.g., tributylmethylammonium, 13 carbon atoms) may be the minimum needed to have sufficient volatility control.

TABLE 3

| | Degree of | Carbon | Volatility |
|---|---|---|---|
| Composition | Substitution | Content | Control |
| Butyl ammonium Dicamba + | 1 | 4 | 5.15% |
| CONTROLMAX | | | |
| Octylammonium Dicamba + | 1 | 8 | 68.7% |
| CONTROLMAX | | | |
| Tripropylammonium Dicamba + | 3 | 9 | 2.7% |
| CONTROLMAX | | | |
| Tributylammonium Dicamba + | 3 | 12 | 64.3% |
| CONTROLMAX | | | |
| Tributylmethylammonium Dicamba + | 4 | 13 | 91.3% |
| CONTROLMAX | | | |
| Tripentylammonium Dicamba + | 3 | 15 | 79.5% |
| CONTROLMAX | | | |
| Hexadecylammonium Dicamba + | 1 | 16 | 56.3% |
| CONTROLMAX | | | |
| Tetratbutylammonium Dicamba + | 4 | 16 | 97.1% |
| CONTROLMAX | | | |
| Trihexylammonium Dicamba + | 3 | 18 | 96.7% |
| CONTROLMAX | | | |
| Cocoammonium (2EO) Dicamba + | 3 | >20 | 79.1% |
| CONTROLMAX | | | |
| Tallowammonium (2EO) Dicamba + | 3 | >20 | 95.2% |
| CONTROLMAX | | | |

### Example 6: Volatility Control of TBA Dicamba Tank Mixtures

Compositions comprising formulated TBA dicamba salt were evaluated for volatility control compatibility with various tank mix partners including POWERMAX (potassium glyphosate), CONTROLMAX (ammonium glyphosate), LIBERTY (ammonium glufosinate available from Bayer CropScience), and ammonium sulfate (AMS). These compositions along with comparative compositions containing CLARITY (diglycolamine dicamba) and either POWERMAX (potassium glyphosate) or CONTROLMAX (ammonium glyphosate) were subjected to volatility testing according to the humidome procedure describe in Example 2. The results are presented in Table 4. The compositions containing TBA dicamba exhibited much lower volatility as compared to those containing CLARITY.

TABLE 4

| | Dicamba | 2,4-D |
|---|---|---|
| | Volatility | Volatility |
| Composition | (ng/L) | (ng/L) |
| CLARITY + POWERMAX | 0.80 | |
| TBA Dicamba + POWERMAX | 0.14 | |
| CLARITY + CONTROLMAX | 8.17 | |
| TBA Dicamba + CONTROLMAX | 0.20 | |
| CLARITY + POWERMAX + AMS | 6.13 | |
| TBA Dicamba + POWERMAX + AMS | 0.25 | |
| CLARITY + POWERMAX + LIBERTY | 5.29 | |
| TBA Dicamba + POWERMAX + LIBERTY | 0.20 | |
| CLARITY + POWERMAX + LIBERTY + | 2.08 | 0.22 |
| 2,4-D amine | | |
| TBA Dicamba + POWERMAX + LIBERTY + | 0.40 | 0.06 |
| 2,4-D amine | | |

### Example 7: Volatility Studies for Dicamba Formulations with TBA

Various compositions containing a dicamba component and a glyphosate component were prepared. The final concentration of dicamba was 1.2 wt. % a.e., and the final concentration of glyphosate was 2.4 wt. % a.e. in each composition. The glyphosate component of each composition was either CONTROLMAX (ammonium glyphosate) or POWERMAX (potassium glyphosate). The dicamba component contained a mixture of monoethanolamine and TBA dicamba or a mixture of diglycolamine and TBA dicamba. These compositions were subjected to volatility testing according to the humidome procedure describe in Example 2. The results are presented in Table 5. The compositions containing TBA dicamba exhibited much lower volatility as compared to those containing CLARITY and CONTROLMAX. The results also demonstrate that a signification volatility reduction can be achieved using sub stoichiometric amounts of TBA with respect to the amount of dicamba.

TABLE 5

| | | Dicamba Volatility |
|---|---|---|
| Composition | pH | (ng/L) |
| CLARITY + CONTROLMAX | 3.78 | 13.188 |
| MEA/TBA Dicamba (1:1 MEA:TBA) + | 4.36 | 0.279 |
| POWERMAX | | |
| MEA/TBA Dicamba (1:1 MEA:TBA) + | 3.72 | 0.683 |
| CONTROLMAX | | |
| DGA/TBA Dicamba (1:1 DGA:TBA) + | 4.37 | 0.239 |
| POWERMAX | | |
| DGA/TBA Dicamba (1:1 DGA:TBA) + | 3.73 | 0.588 |
| CONTROLMAX | | |

Attempts were then made to formulate the TBA-containing compositions as concentrates. Formulations containing a molar ratio of 0.5:0.5:1 MEA/DGA:TBA:dicamba were made as solution concentrates containing 45 wt % a.e. dicamba with 1:1 molar ratio of MEA:TBA dicamba and 43 wt % a.e. with 1:1 molar ratio of DGA:TBA dicamba. Dilutions of these compositions were mixed with POWERMAX or CONTROLMAX, respectively, and subjected to volatility testing according to the humidome procedure describe in Example 2. Both formulations showed volatility control of 95% and 96%, respectively, as compared volatility measured from application of a tank mix of CLARITY (diglycolamine dicamba) and CONTROLMAX (ammonium glyphosate).

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and processes without departing from the scope of the invention, it is intended that all matter contained in the above description shall be interpreted as illustrative and not in a limiting sense.

1-191. (canceled)

192. An herbicidal composition comprising:
an auxin herbicide, in the form of a salt thereof comprising a first cation;
an agrochemical component comprising one or more agrochemicals that promote the volatilization of the auxin herbicide, wherein the agrochemical component comprises a source of ammonium ions, an organic amine salt of a co-herbicide, or a mixture thereof; and
an adjuvant comprising a second cation selected from the group consisting of:
(a) a quaternary ammonium cation of Formula Ia 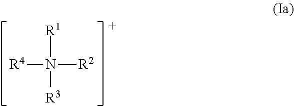
wherein R¹, R², and R³ are each independently C3-C12 hydrocarbyl, R⁴ is C1-C12 hydrocarbyl, and the total number of carbon atoms in R¹, R², R³, and R⁴ is at least 13;
(b) a nitrogen heterocycle cation of Formula IIa 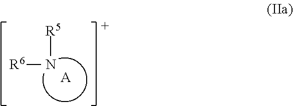
wherein A is a 5 or 6-membered heterocyclic ring; R⁵ is a C1-C20 alkyl; R⁶ is hydrogen or a C₁-C₆ alkyl;
(c) a phosphonium cation of Formula IIIa 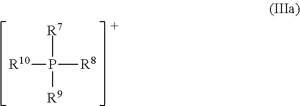
wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof;
and wherein when the herbicidal composition is in the form of an herbicidal concentrate comprising a co-herbicide, the total herbicide concentration is at least 240 grams per liter on an acid equivalent (a.e.) basis.

193. The composition of claim 192 wherein the second cation comprises a quaternary ammonium cation of Formula Ia 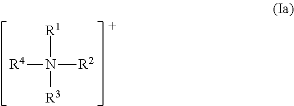
wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13.

194. The composition of claim 192 wherein the second cation comprises a nitrogen heterocycle cation of Formula IIa 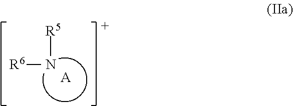
wherein A is a 5 or 6-membered heterocyclic ring; R⁵ is a C₁-C₂₀ alkyl; R⁶ is hydrogen or a C₁-C₆ alkyl.

195. The composition of claim 192 wherein the second cation comprises a phosphonium cation of Formula IIIa 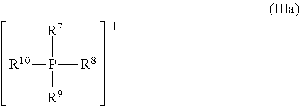
wherein R⁷, R⁸, and R⁹ are each independently C3-C12 hydrocarbyl, R¹⁰ is C1-C12 hydrocarbyl, and the total number of carbon atoms in R⁷, R⁸, R⁹, and R¹⁰ is at least 13.

196. The composition of claim 192 wherein the agrochemical component comprises a source of ammonium ions selected from the group consisting of ammonium glyphosate, ammonium glufosinate, ammonium sulfate, ammonium thiosulfate, ammonium oxalate, ammonium nitrate, urea ammonium nitrate, ammonium thiocyanate, ammonium chloride, ammonium phosphate, ammonium isethionate, ammonium lactate, ammonium hydroxide, ammonium bicarbonate, ammonium carbonate, ammonium sulfide, and mixtures thereof.

197. The composition of claim 192 wherein the agrochemical component comprises an organic amine salt of glyphosate or glufosinate selected from the group consisting of monoethanolamine, n-propylamine, isopropylamine, ethylamine, dimethylamine, ethylenediamine, hexamethylenediamine, and mixtures thereof.

198. The composition of claim 192 wherein the molar ratio of the auxin herbicide to the adjuvant is from about 2:1 to about 10:1.

199. The composition of claim 192 wherein the first cation is selected from the group consisting of sodium, potassium, monoethanolammonium, diethanolammonium, isopropylammonium, diglycolammonium, and dimethyl ammonium.

200. The composition of claim 192 wherein the auxin herbicide is selected from the group consisting of dicamba; 2,4-dichlorophenoxyacetic acid (2,4-D); 4-(2,4-dichlorophenoxy)butyric acid (2,4-DB); dichloroprop; 2-methyl-4-chlorophenoxyacetic acid (MCPA); 4-(4-chloro-2-methylphenoxy)butanoic acid (MCPB); 4-chlorophenoxyacetic acid; 2,4,5-trichlorophenoxyacetic acid (2,4,5-T); aminopyralid; clopyralid; fluroxypyr; triclopyr; mecoprop; picloram; quinclorac; aminocyclopyrachlor; and mixtures thereof.

201. The composition of claim 192 wherein the auxin herbicide comprises dicamba.

202. A method of preparing an herbicidal concentrate composition comprising an auxin herbicide, wherein the method comprises combining:
an auxin herbicide acid;
a neutralizing base comprising a first cation; and
an adjuvant comprising a hydroxide salt comprising a second cation, wherein the hydroxide salt is selected from the group consisting of:
(a) a quaternary ammonium salt of Formula I 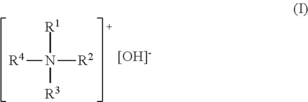
wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;
(b) a salt containing a nitrogen heterocycle of Formula II 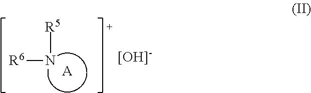
wherein A is a 5 or 6-membered heterocyclic ring; R⁵ is a C₁-C₂₀ alkyl; R⁶ is hydrogen or a C₁-C₆ alkyl;
(c) a phosphonium salt of Formula III 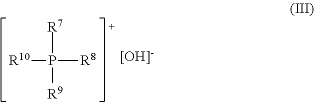
wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof.

203. A method of preparing an herbicidal tank mixture, wherein the method comprises combining:
an auxin herbicide, in the form of a salt thereof comprising a first cation;
an agrochemical component comprising one or more agrochemicals that promote the volatilization of the auxin herbicide; and
an adjuvant comprising a hydroxide salt comprising a second cation, wherein the hydroxide salt is selected from the group consisting of:
(a) a quaternary ammonium salt of Formula I 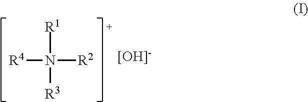
wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;
(b) a salt containing a nitrogen heterocycle of Formula II 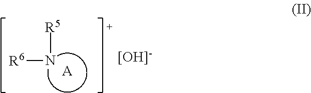
wherein A is a 5 or 6-membered heterocyclic ring; R⁵ is a C₁-C₂₀ alkyl; R⁶ is hydrogen or a C₁-C₆ alkyl;
(c) a phosphonium salt of Formula III 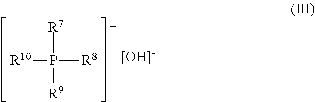
wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof.

204. A method of preparing an herbicidal mixture, wherein the method comprises combining:
an auxin herbicide, in the form of a salt thereof comprising a cation; and
an agrochemical component comprising one or more agrochemicals that promote the volatilization of the auxin herbicide, wherein the agrochemical component comprises a source of ammonium ions, an organic amine salt of a co-herbicide, or a mixture thereof,
wherein the cation is selected from the group consisting of:
(a) a quaternary ammonium cation of Formula Ia 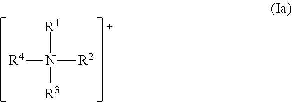
wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;
(b) a nitrogen heterocycle cation of Formula IIa 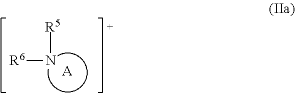
wherein A is a 5 or 6-membered heterocyclic ring; R⁵ is a C₁-C₂₀ alkyl; R⁶ is hydrogen or a C₁-C₆ alkyl;
(c) a phosphonium cation of Formula IIIa 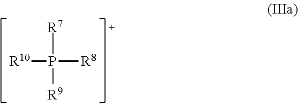
wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof.

205. The method of claim 204 wherein the agrochemical component comprises a source of ammonium ions selected from the group consisting of ammonium glyphosate, ammonium glufosinate, ammonium sulfate, ammonium thiosulfate, ammonium oxalate, ammonium nitrate, urea ammonium nitrate, ammonium thiocyanate, ammonium chloride, ammonium phosphate, ammonium isethionate, ammonium lactate, ammonium hydroxide, ammonium bicarbonate, ammonium carbonate, ammonium sulfide, and mixtures thereof.

206. The method of claim 204 wherein the agrochemical component comprises an organic amine salt of glyphosate or glufosinate selected from the group consisting of monoethanolamine, n-propylamine, isopropylamine, ethylamine, dimethyl amine, ethylenediamine, hexamethylenediamine, and mixtures thereof.

207. The method of claim 203 wherein the adjuvant comprises a quaternary ammonium salt of Formula I 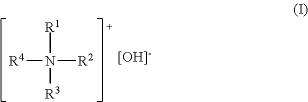
wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13.

208. The method of claim 203 wherein the adjuvant comprises a salt containing a nitrogen heterocycle of Formula II 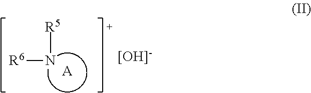
wherein A is a 5 or 6-membered heterocyclic ring; R⁵ is a C₁-C₂₀ alkyl; R⁶ is hydrogen or a C₁-C₆ alkyl.

209. The method of claim 203 wherein the adjuvant comprises a phosphonium salt of Formula III 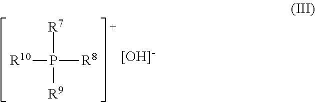
wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13.

210. A method of preparing an herbicidal tank mixture, wherein the method comprises combining:
an auxin herbicide, in the form of a salt thereof;
an agrochemical component selected from the group consisting of ammonium glufosinate, ammonium glyphosate, ammonium sulfate, and combinations thereof; and
an adjuvant comprising a quaternary ammonium salt selected from the group consisting of tetrabutylammonium hydroxide and tributylmethylammonium hydroxide, wherein the molar ratio of the auxin herbicide to the quaternary ammonium salt is from about 2:1 to about 10:1.

211. An herbicidal concentrate composition comprising:
a first auxin herbicide salt comprising a first cation selected from the group consisting of sodium, potassium, monoethanolammonium, diethanolammonium, isopropylammonium, diglycolammonium, dimethylammonium and mixtures thereof;
a second salt of the auxin herbicide comprising a second cation selected from the group consisting of:
(a) a quaternary ammonium cation of Formula Ia 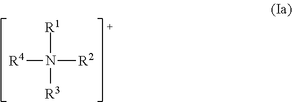
wherein R¹, R², and R³ are each independently C₃-C₁₂ hydrocarbyl, R⁴ is C₁-C₁₂ hydrocarbyl, and the total number of carbon atoms in R¹, R², R³, and R⁴ is at least 13;
(b) a nitrogen heterocycle cation of Formula IIa 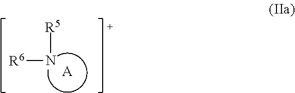
wherein A is a 5 or 6-membered heterocyclic ring; R⁵ is a C₁-C₂₀ alkyl; R⁶ is hydrogen or a C₁-C₆ alkyl;
(c) a phosphonium cation of Formula IIIa 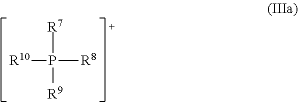
wherein R⁷, R⁸, and R⁹ are each independently C₃-C₁₂ hydrocarbyl, R¹⁰ is C₁-C₁₂ hydrocarbyl, and the total number of carbon atoms in R⁷, R⁸, R⁹, and R¹⁰ is at least 13; and mixtures thereof; and
wherein the concentration of the first cation is no more than about 90% of the auxin herbicide on an acid molar basis and the composition comprises the auxin herbicide in a concentration of at least 50 grams per liter on an acid equivalent (a.e.) basis.
